(19) United States
(12) Patent Application Publication
(10) Pub. No.: US 2006/0066594 A1
(43) Pub. Date: Mar. 30, 2006

(54) Systems and methods for driving a bi-stable display element

(76) Inventor: Karen Tyger, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/062,143

(22) Filed: Feb. 18, 2005

Related U.S. Application Data
(60) Provisional application No. 60/613,418, filed on Sep. 27, 2004.

(51) Int. Cl. G09G 5/00

(52) U.S. Cl. 345/204

(57) ABSTRACT

Due to the bi-stable nature of interferometric modulator elements, the state of each modulator element may be held at either an actuated or a released state with a common voltage difference. Because modulator elements often require less time to change states than is allotted in a line time, power drawn by an array of modulator elements may be reduced by disabling one or both of a row and column voltage boost module, which are configured to amplify an input power source to a level that is suitable for driving modulator elements. If the column voltage is removed during the latter portion of a line time, for example, the row voltage is set to a level that is sufficient to maintain a voltage difference between the row voltage and the floating column voltage within a stability voltage range during the remainder of the line time.

### CROSS-REFERENCE TO RELATED APPLICATIONS

This application claims priority under 35 U.S.C. § 119(e) to U.S. Provisional Application Ser. No. 60/613,418, filed on Sep. 27, 2004, which is hereby expressly incorporated by reference in its entirety.

### BACKGROUND

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. An interferometric modulator may comprise a pair of conductive plates, one or both of which may be partially transparent and capable of relative motion upon application of an appropriate electrical signal. One plate may comprise a stationary layer deposited on a substrate, the other plate may comprise a metallic membrane suspended over the stationary layer. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

In one embodiment, a method is provided for updating a display region, the display region comprising a plurality of modulator elements arranged in a row and column configuration, wherein the modulator elements each have an actuated and a released state that may be selected by a voltage difference between a row electrode and a column electrode that are electronically coupled to respective modulator elements, each of the modulator elements being configured to maintain the state of the modulator element when a voltage within a stability window is applied between the row electrode and the column electrode of the respective modulator element, wherein each row of the modulator element is allotted a line time for changing states of the modulator elements of the respective row. The method comprises generating at least one row voltage with a row level shifter, generating at least one column voltage with a column level shifter, applying at least one row voltage to a selected row of modulator elements, applying at least one column voltage to selected columns of modulator elements according to a desired state for the modulator elements, and disabling the column level shifter prior to the completion of the line time, wherein the state of the modulator elements in the selected row are maintained by a voltage difference between the row voltage and a reference voltage, wherein the voltage difference is within the stability window.

In another embodiment, a display comprises a row booster configured to generate a row voltage, a column booster configured to generate a column voltage, an array comprising a plurality of modulator elements, each of the modulator elements being connected to a column electrode and a row electrode and being configured to be driven by the row voltage and the column voltage, wherein a state of the modulator elements in a respective row of the array may be modified during a line time in which the row voltage is connected to the respective row electrode, and a disable module configured to disable one of the boosters during a portion of the line time.

In another embodiment, a method is provided for reducing power consumption of a display driver configured to drive each of a plurality of modulator elements in an array of modulator elements, wherein the display driver comprises a level shifter configured to generate an amplified voltage for driving the modulator elements. The method comprises (a) selecting a set of the modulator elements to be refreshed, (b) refreshing the selected set of modulator elements, wherein the amplified voltage is applied to certain of the selected set of modulator elements in order to change a state of the certain modulator elements, (c) after refreshing the selected set of modulator elements, disabling the level shifter for a predetermined time, (d) after the predetermined time, enabling the level shifter, and (d) repeating steps (a)-(d).

In another embodiment, a display driver configured to drive each of a plurality of modulator elements in an array of modulator elements comprises a voltage level shifter and means for disabling the voltage level shifter for a predetermined time after refreshing a selected set of modulator elements.

In another embodiment, a display comprises a row booster configured to generate a row voltage, a column booster configured to generate a column voltage, an array comprising a plurality of bi-stable display elements, each of the display elements being connected to a column electrode and a row electrode and being configured to be driven by the row voltage and the column voltage, wherein a state of the display elements in a respective row of the array may be modified during a line time in which the row voltage is connected to the respective row electrode, and a disable module configured to disable one of the boosters during a portion of the line time.

### BRIEF DESCRIPTION OF THE DRAWINGS

FIG. 1 is an isometric perspective view depicting a portion of one embodiment of an interferometric modulator display in which a movable mirror of a first interferometric modulator is in a reflective, or “on,” position at a predetermined distance from a fixed mirror and the movable mirror of a second interferometric modulator is in a non-reflective, or “off” position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of sets of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 3.

FIG. 6A is a cross section of the device of FIG. 1.

FIG. 6B is a cross section of an alternative embodiment of an interferometric modulator.

FIG. 6C is a cross section of an alternative embodiment of an interferometric modulator.

FIG. 7 is a timing diagram showing a series of row and column signals applied to the 3×3 array of FIG. 2, for example, which will result in the display arrangement illustrated in FIG. 5A, where actuated pixels are non-reflective.

FIG. 8 is a block diagram of an exemplary display driver that is configured to output driver signals for an array of modulator elements of a display device.

FIG. 9 is a block diagram of an exemplary short pulse module that is configured to output an enable signal, which may be provided to the column level shifter of FIG. 8 in order to control the operation of the level shifter.

FIG. 10 is a flow chart illustrating an exemplary method of controlling a level shifter.

### DETAILED DESCRIPTION OF PREFERRED EMBODIMENTS

Due to the bi-stable nature of interferometric modulator elements, the state of each modulator element may be held at either an actuated or a released state with a common voltage difference. Because modulator elements often require less time to change states than is allotted in a line time, power drawn by an array of modulator elements may be reduced by disabling one or both of a row and column voltage boost module, which are configured to amplify an input power source to a level that is suitable for driving modulator elements. If the column voltage is removed during the latter portion of a line time, for example, the row voltage is set to a level that is sufficient to maintain a voltage difference between the row voltage and the floating column voltage within a stability voltage range during the remainder of the line time.

The following detailed description is directed to certain specific embodiments of the invention. However, the invention can be embodied in a multitude of different ways. In this description, reference is made to the drawings wherein like parts are designated with like numerals throughout. As will be apparent from the following description, the invention may be implemented in any device that is configured to display an image, whether in motion (e.g., video) or stationary (e.g., still image), and whether textual or pictorial. More particularly, it is contemplated that the invention may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures (e.g., tile layouts), packaging, and aesthetic structures (e.g., display of images on a piece of jewelry). More generally, the invention may be implemented in electronic switching devices.

Spatial light modulators used for imaging applications come in many different forms. Transmissive liquid crystal display (LCD) modulators modulate light by controlling the twist and/or alignment of crystalline materials to block or pass light. Reflective spatial light modulators exploit various physical effects to control the amount of light reflected to the imaging surface. Examples of such reflective modulators include reflective LCDs, and digital micromirror devices.

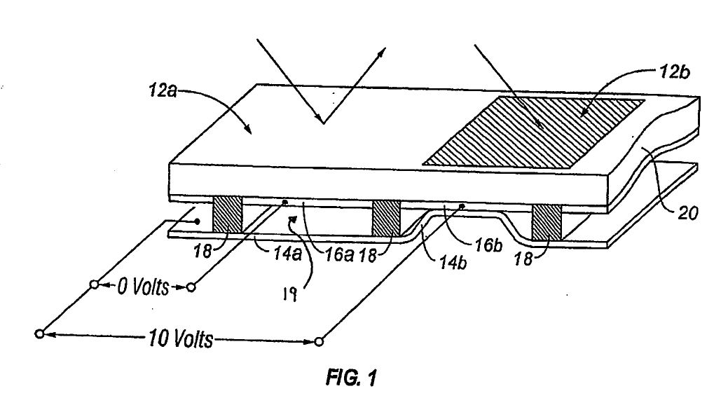

Another example of a spatial light modulator is an interferometric modulator that modulates light by interference. One interferometric modulator display embodiment comprising a reflective MEMS display element is illustrated in FIG. 1. In these devices, the pixels are in either a bright or dark state. In the bright (“on” or “open”) state, a bi-stable display element reflects incident light to a user. When in the dark (“off” or “closed”) state, a bi-stable display element is light absorbing and reflects little light to the user. Depending on the embodiment, the display 110 may be configured to reflect light in the “off” state and absorb light in the “on” state, i.e., the light reflectance properties of the “on” and “off” states are reversed. MEMS pixels can also be configured to reflect only selected colors, producing a color display rather than black and white.

FIG. 1 is an isometric perspective view depicting two adjacent pixels in a row of one embodiment of a visual display, comprising a MEMS interferometric modulator. An interferometric modulator display comprises a row/column array of these interferometric modulators. Each interferometric modulator includes a pair of mirrors positioned at a distance from each other to form a resonant optical cavity. In one embodiment, one of the mirrors may be moved between at least two positions. In the first position, the movable mirror is positioned at a first distance from the other mirror so that the interferometric modulator is predominantly reflective. In the second position, the movable mirror is positioned at a different distance, e.g., adjacent to the fixed mirror, such that the interferometric modulator is predominantly absorbing.

The depicted portion of the pixel array includes two adjacent interferometric modulators 12a and 12b in a row. In the depicted embodiment of the interferometric modulator, a movable mirror 14a is illustrated in the reflective (“released”, “on”, or “open”) position at a predetermined distance from a fixed, partial mirror 16a, 16b. The movable mirror 14b of the interferometric modulator 12b is illustrated in the non-reflective, absorbent (“actuated”, “off”, or “closed”) position adjacent to the partial mirror 16b.

The fixed mirrors 16a, 16b are electrically conductive, and may be fabricated, for example, by depositing layers of chromium and indium-tin-oxide onto a transparent substrate 18 that are patterned into parallel strips, and may form column electrodes. The movable mirrors 14a, 14b along the row may be formed as a series of parallel strips of a deposited metal layer or layers (orthogonal to the column electrodes 16a, 16b) on the substrate 18, with aluminum being one suitable material, and may form row electrodes.

When a potential difference is applied to a selected row and column, the capacitor formed at the intersection of the row and column electrodes at the corresponding pixel charges, and electrostatic forces pull the electrodes together. If the voltage is high enough, the movable electrode is forced against the stationary electrode (a dielectric material may be deposited on the stationary electrode to prevent shorting and control the separation distance) as illustrated by the pixel on the right in FIG. 1. The behavior is the same regardless of the polarity of the applied potential difference. In this way, row/column actuation can control the reflective vs. absorbing state of each pixel.

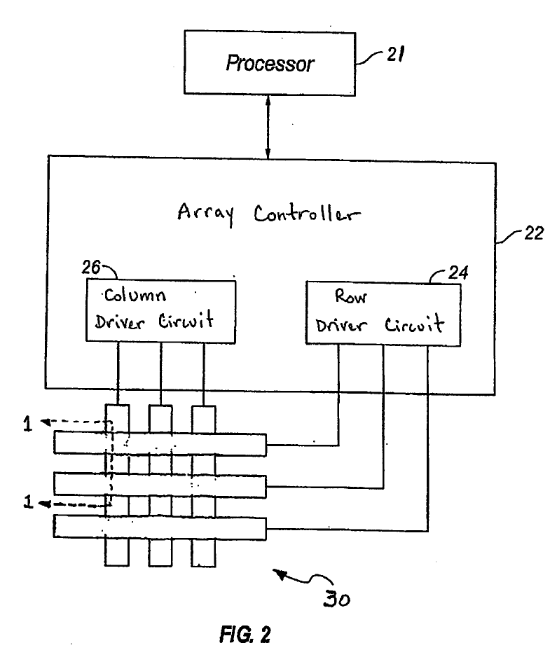

FIGS. 2 through 5 illustrate one exemplary process and system for using an array of interferometric modulators in a display application. FIG. 2 is a system block diagram illustrating one embodiment of an electronic device that may incorporate aspects of the invention. In the exemplary embodiment, the electronic device includes a processor 20 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 20 may be configured to execute one or more software modules. In addition to executing an operating system, the processor may be configured to execute one or more software applications, including a web browser, a telephone application, an email program, or any other software application.

In one embodiment, the processor 20 is also configured to communicate with an array controller 22. In one embodiment, the array controller 22 includes a row driver circuit 24 and a column driver circuit 26 that provide signals to the array 30. The cross section of the array illustrated in FIG. 1 is shown by the lines 1-1 in FIG. 2. Portions of the array controller 22 as well as additional circuitry and functionality may be provided by a graphics controller which is typically connected between the actual display drivers and a general purpose microprocessor. Exemplary embodiments of the graphics controller include 69030 or 69455 controllers from Chips and Technology, Inc., the S1D1300 series from Seiko Epson, and the Solomon Systech 1906.

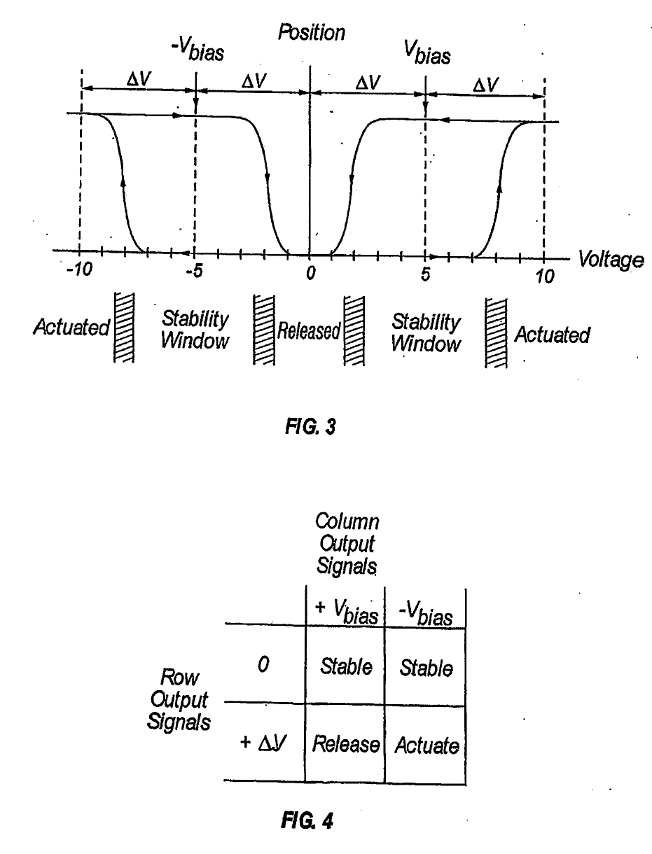

For MEMS interferometric modulators, the row/column actuation protocol may take advantage of a hysteresis property of these devices illustrated in FIG. 3. It may require, for example, a 10 volt potential difference to cause a pixel to deform from the released state to the actuated state. However, when the voltage is reduced from that value, the pixel may not release until the voltage drops below 2 volts. There is thus a range of voltage, about 3 to 7 V in the example illustrated in FIG. 3, where there exists a stability window within which the device will remain in whatever state it started in. The row/column actuation protocol is therefore designed such that during row strobing, pixels in the strobed row that are to be actuated are exposed to a voltage difference of about 10 volts, and pixels that are to be released are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or released pre-existing state. Since each pixel of the interferometric modulator, whether in the actuated or released state, is essentially a capacitor formed by the fixed and moving mirrors, this stable state can be held at a voltage within the hysteresis window with almost no power dissipation. Essentially no current flows into the pixel if the mirror is not moving and the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, asserting the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of other protocols for driving row and column electrodes of pixel arrays to produce display frames are also well known and may be used in conjunction with the present invention.

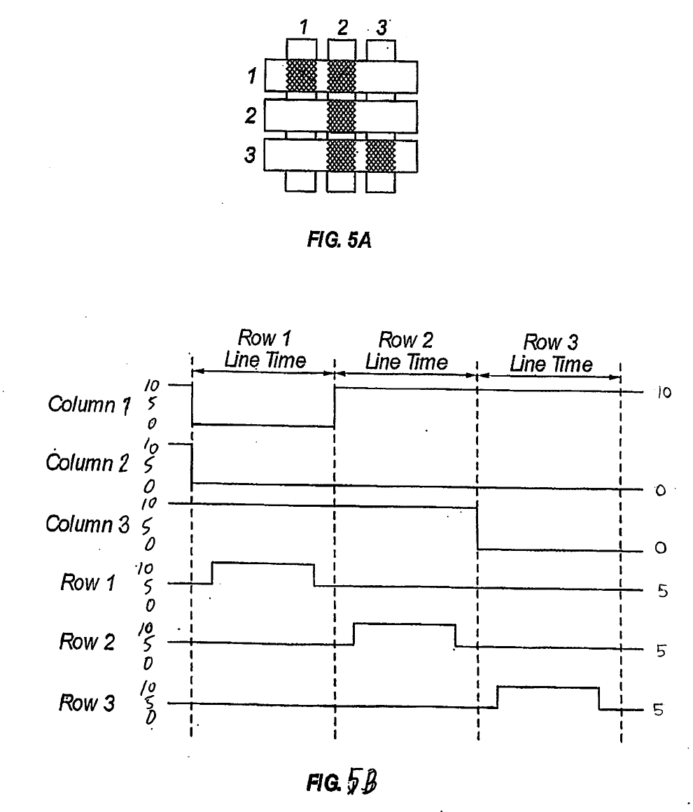

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV. Releasing the pixel is accomplished by setting the appropriate column to +V_{bias}, and the appropriate row to the same +ΔV. In those rows where the row voltage is held at zero volts, the pixels are stable in whatever state they were originally in, regardless of whether the column is at +V_{bias}, or −V_{bias}.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 5 volts, and all the columns are at 10 volts. In this state, all pixels are stable in their existing actuated or released states.

In the FIG. 5A frame, pixels (1,1), (1,2), (2,2), (3,2) and (3,3) are actuated. To accomplish this, during a “line time” for row 1, columns 1 and 2 are set to 0 volts, and column 3 is set to 10 volts. This does not change the state of any pixels, because all the pixels remain in the 3-7 volt stability window. Row 1 is then strobed with a pulse that goes from 5 volts, up to 10 volts, and back to 5 volts. This actuates the (1,1) and (1,2) pixels and releases the (1,3) pixel. No other pixels in the array are affected. To set row 2 as desired, column 2 is set to 0 volts, and columns 1 and 3 are set to 10 volts. The same strobe applied to row 2 will then actuate pixel (2,2) and release pixels (2,1) and (2,3). Again, no other pixels of the array are affected. Row 3 is similarly set by setting columns 2 and 3 to 0 volts, and column 1 to 10 volts. The row 3 strobe sets the row 3 pixels as shown in FIG. 5A. After writing the frame, the row potentials are zero, and the column potentials can remain at either 10 or 0 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the present invention.

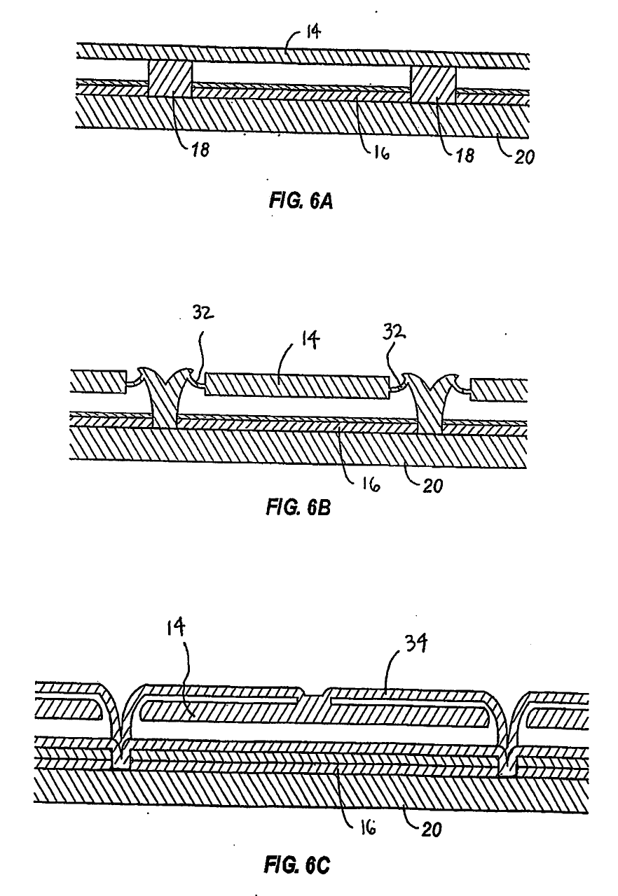

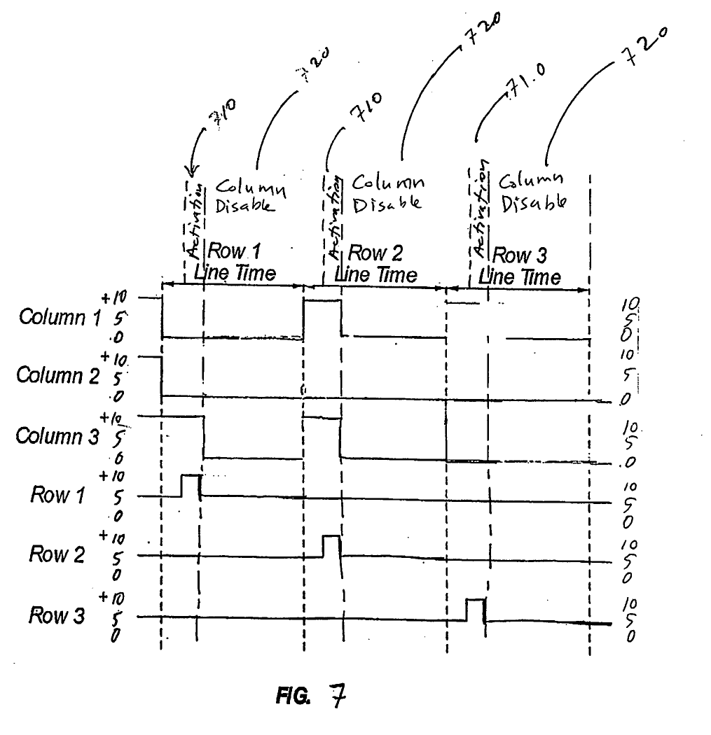

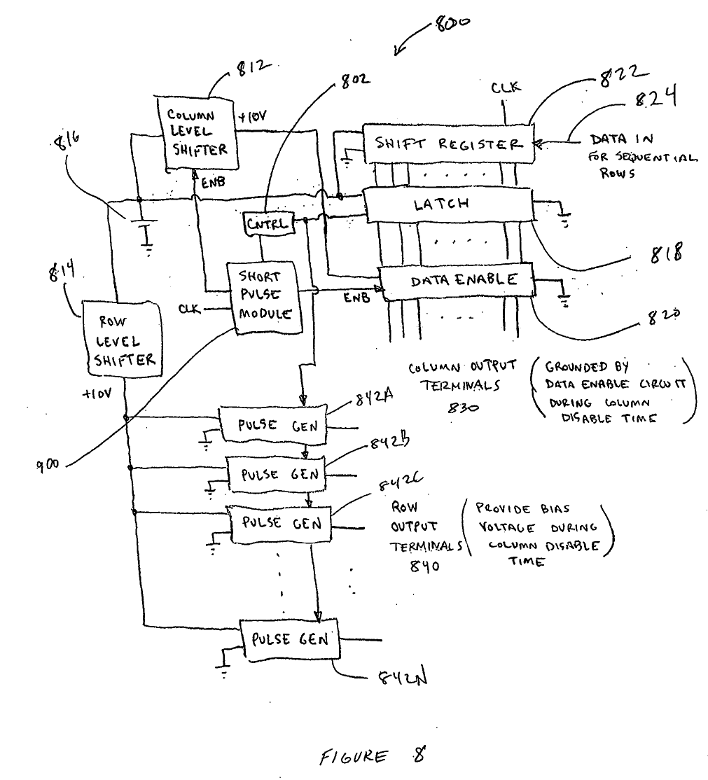

The details of the structure of interferometric modulators that operate in accordance with the principles set forth above may vary widely. For example, FIGS. 6A-6C illustrate three different embodiments of the moving mirror structure. FIG. 6A is a cross section of the embodiment of FIG. 1, where a strip of metal material 16 is deposited on orthogonally extending supports 18. In FIG. 6B, the moveable mirror is attached to the supports at the corners only, on tethers 32. In FIG. 6C, the mirror 16 is suspended from a deformable film 34. This embodiment has benefits because the structural design and materials used for the mirror 16 can be optimized with respect to the optical properties, and the structural design and materials used for the deformable layer 34 can be optimized with respect to desired mechanical properties. The production of various types of interferometric devices is described in a variety of published documents, including, for example, U.S. Published Application 2004/0051929, which is incorporated by reference in its entirety.

Low power consumption on electronic devices, and especially those devices that are powered by batteries, such as portable devices, is desirable. The electronics that drive the display typically consume a large portion of the total device power and, thus, decreasing the power consumption of driver electronics is desirable.

FIG. 7 is a timing diagram showing a series of row and column signals applied to the 3×3 array of FIG. 2, for example, which will result in the display arrangement illustrated in FIG. 5A, where actuated pixels are non-reflective. In the embodiment of FIG. 7, the array of modulator elements are each actuated by a voltage difference of about 10 volts, released by a voltage difference of about 0 volts, and maintained at their position by a stability voltage difference in the range of about 3 to 7 volts. In other embodiments the row and column voltages may be set to any level that is suitable for driving the modulator elements of the display

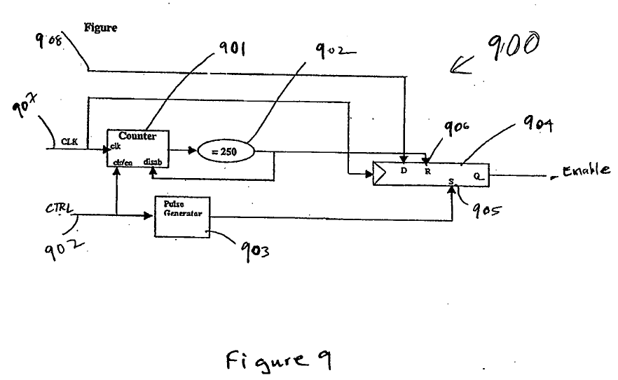

In the FIG. 5A frame, pixels (1,1), (1,2), (2,2), (3,2) and (3,3) are actuated. Thus, during the Row 1 line time, the Row 1 voltage is strobed with a pulse that goes from 5 volts, up to 10 volts, and back to 5 volts. Near the beginning of the Row 1 line time, Columns 1 and 2 are set to 0 volts and Column 3 is set to 10 volts. Accordingly, the (1,1) and (1,2) pixel are actuated (due to the about 10 volts applied across the modulator elements) and the (1,3) pixel is released (due to the about 0 volts applied across the modulator element). In the embodiment of FIG. 7, the Row 1 elements are changed to their desired states, as indicated above, during an activation time 710 in which the row voltage is strobed and the column voltages are set to the appropriate levels according to a data signal 804 (FIG. 8). As illustrated in FIG. 7, the activation time 710 is less than the line time. In one embodiment, an interferometric modulator needs about 10 microseconds to change states and, therefore, the activation time is set to about 10 microseconds. However, in other embodiments the activation time 710 may be set to any other value that is less than the line time.

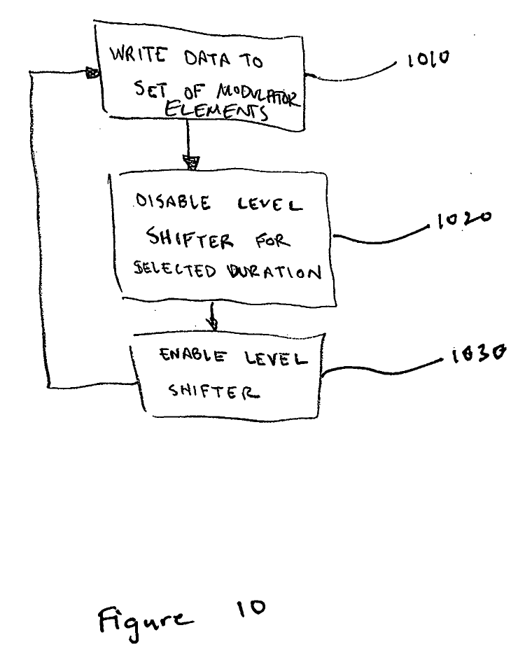

After the activation time 710, the state of the elements in Row 1 may be maintained by application of the stability voltage of about 5 volts, for example, across each of the modulator elements in Row 1. Advantageously, a column level shifter 812 (FIG. 8) that is configured to supply the voltages that are applied to the column terminals may be disabled after the activation time 710, thereby reducing the power drawn from a power source during the column disable time 720. A data enable module 820 (FIG. 8) may be configured to ground the column terminals of the array of modulator elements during this column disable time 720. Thus, with 0 volts on each of the columns of the array and 5 volts on the Rows, about 5 volts is applied across each modulator element, maintaining each modulator element in its current state. The short pulse module 900 (FIGS. 8 and 9) may enable the column level shifter 812 (FIG. 8) near the beginning of a subsequent line time so that the appropriate voltage levels for the next row are provided to the column terminals.

FIG. 8 is a block diagram of an exemplary display driver 800 that is configured to output driver signals for an array of modulator elements of a display device. In particular, the display driver 800 outputs signals on row output terminals 840 that are coupled to each of the rows of modulator elements and signals on column output terminals 830 that are coupled to each of the columns of modulator elements. Advantageously, the display driver 800 disables at least a portion of its circuitry during the column disable time 720, thereby reducing the power consumed by the display driver 800. In the exemplary embodiment of FIG. 8, during the column disable time 720 the column output terminals are grounded and the row output terminals 840 provide a bias voltage, e.g., 5 volts.

The exemplary display device 800 includes a column level shifter 812 and a row level shifter 814, which are each electrically coupled to a power source 806, such as a battery. The level shifters 812, 814 are configured to modify the voltage signal supplied by the power source 806 to provide one or more voltage levels that are necessary for driving the modulator elements of the array. For example, modulator elements in an exemplary array may require a voltage difference of 10 volts in order to actuate, and a voltage difference of 5 volts to maintain a state. If the power source 806 provides only 3 volts, the electrical signal from the power source 806 requires boosting in order to provide the voltage levels necessary to actuate modulator elements. The voltages for the row terminals, such as five and ten volts, are provided by the row level shifter 814 and the voltages for the column terminals, such as five and ten volts, are provided by the column level shifter 814.

Each of the level shifters 812, 814 may include multiple DC-DC conversion circuitry, operational amplifiers, etc., configured to boost the electrical signal from the power source 816 to one or more desired levels. While the embodiments described herein discuss the use of a voltage booster configured to increase the source voltage to a voltage necessary for driving the modulator elements, those of skill in the art will recognize that in other embodiments the level shifters 812, 814 may be configured to reduce the input voltage to a voltage necessary to drive the modulator elements.

The exemplary display driver 800 includes a shift register 822 that receives data 824 indicating the desired states of each of the modulator elements in a row of the array. In one embodiment, the shift register 822 has a width that is equal to the number of columns in the array of modulator elements. Accordingly, the shift register 822 may store data indicative of a next state of an entire row of modulator elements. A latch 818 is coupled to the shift register 822 and is configured to receive the data 824 from the shift register 822. In one embodiment, latch 818 outputs the data received from the shift register 822 at the beginning of each line time. A data enable module 820 is electrically coupled to the latch 818 and is configured to control when the data should be provided to the column output terminals 830. In one embodiment, the data enable module 820 is configured to output data for a current row of modulator elements during the activation time 710 for that row.

In the embodiment of FIG. 8, the data enable module 820 is electrically coupled to the column level shifter 812 so that the appropriate voltage levels are provided to the column output terminals 830. For example, the data 824 may contain binary data in the form of 3 volt and 0 volt signals indicative of desired states of modulator elements. In the embodiment of FIG. 8, the data enable module 820 is configured to output a 10 volt signal on each column output terminal 830 that corresponds with a 3 volt signal received from the latch 818. Accordingly, the state of the modulator elements may be stored in the shift register 824 and latch 818 using lower voltage levels than are necessary to change the state of modulator elements.

In the embodiment of FIG. 8, a control signal (CTRL) module 702 is coupled to the latch 718 and is configured to provide a horizontal sync output signal indicating when a new line time begins. In one embodiment, the latch 818 latches the shift register 822 outputs to the latch outputs when the control module 702 indicates that a new line time has started. This data is then passed through the data enable module 820 during the activation time to the column output terminals.

As illustrated in FIG. 8, the exemplary display driver 800 includes a short pulse module 820 that is configured to provide an enable signal that may be used to control the operation of the column level shifter 812 as well as the data enable module 820. In general, the short pulse module 820 is configured to disable the column level shifter 814 after the activation time 710 has passed and cause the column level shifter 814 to remain deactivated until the next line time begins. In this way, the column level shifter 814 is disabled for a portion of each line time, the power used by the column level shifter 814 is decreased, and the power consumed by the array of modulator elements is decreased. In one embodiment, the short pulse module 820 is also coupled to the data enable module 820 and provides a signal indicating when the output to all of the columns should be set to ground. In particular, during the column disable time 720 (FIG. 7), while the column level shifter 812 is disabled, the short pulse module 820 may signal to the data enable module 820 that the column output terminals 830 should all be grounded. In this way, the column output terminals 830 are prevented from floating during the disable time 720 while the column level shifter 812 is disabled. With the row level shifter 814 remaining on during the column disable time 720, a bias voltage, such as 5 volts, will be maintained on the modulator elements by providing the bias voltage on the row output terminals 840. As noted above, the short pulse module 820 is configured so that deactivation of the column level shifter 812 occurs only after the modulator elements of the current row of the array have had sufficient time to change states, where necessary.

In one embodiment, short pulse module 820 also controls the length of the Row strobe time, e.g., the time that the Row voltage goes to 10 volts in the example of FIG. 7, as well as the deactivation of the column level shifter 812. Exemplary display driver 800 includes a pulse generator 842 coupled to each of the row output terminals. The pulse generators 842 are configured to sequentially provide the row strobe to rows of the array. For example, during a first line time, pulse generator 842A may provide a row strobe to a first row of the array, during a second line time, pulse generator 842B may provide a row strobe to a second row of the array, and so on. In the embodiment of FIG. 8, the control module 802 is electrically coupled to the pulse generators 842 and indicates when each sequential line time begins.

In one embodiment, the Row strobe time is substantially equal to the activation time 710. In this embodiment, the row output terminals 840 return to a bias voltage, e.g., 5 volts, during the column disable time 720. In one embodiment, the short pulse module 820 provides an enable signal (not shown) to the pulse generators 842 indicating when the row voltage terminals 740 should be returned to their bias voltage. In one embodiment, when the enable signal from the short pulse module 820 is asserted, both the row and column level shifters 812, 814 are active and the selected pulse generator 842 outputs 10 volts to its respective row output terminal. In this embodiment, when the enable signal is deasserted, such as at the end of activation time 710, the selected pulse generator 842 returns to 5 volts, the column level shifter 812 is disabled, and the data enable grounds the column output terminals 830. Thus, when the enable signal is deasserted, the column level shifter 812 is not active and does not draw power from the power supply 816.

While operation of the display driver 800 has been described with reference to disabling of the column level shifter 812 during a portion of the line time, in other embodiments that will be apparent to those of ordinary skill in the art, the row level shifter 814 may be disabled rather than the column level shifter 812.

The short pulse module 820 may comprise various combinations of electrical components that are configured to disable the column boost module 814 after the activation time. FIG. 9, described in detail below, is a block schematic of one exemplary configuration of components that may be used in a short pulse module 820.

FIG. 9 is a block diagram of an exemplary short pulse module 900 that is configured to output an enable signal, which may be provided to the column level shifter 812 (FIG. 8) in order to control the operation of the level shifter. In one embodiment, the enable signal may also be transmitted to the pulse generator 842 (FIG. 8) in order to control the row strobe time. The exemplary short pulse module 900 includes 3 inputs, an activation signal 908, which provides a desired signal level for the enable signal, a Clock signal (CLK) 1007, and a CTRL signal 902, such as from the CTRL module 802.

In the embodiment of FIG. 9, CLK 802 may be a square wave oscillating at 25 MHz, which is a typical VGA data rate. Alternatively, CLK 802 may be any other frequency of clock signal. A counter 901 is configured to count every CLK pulse and the CTRL signal 902 input resets the counter 901 to zero at the beginning of each line time. A set-reset flip-flop 904 provides the enable output. As those of skill in the art will recognize, the flip-flop 904 is triggered to output the activation signal 908 when the set input 905 is asserted. In one embodiment, when the enable signal is equal to the activation signal 908, the selected Row is strobed and the column level shifter 812 is active. The output of the flip-flop 904 is held until a signal is asserted at a reset input 906.

In operation, a pulse generator 903 may be used to generate a one CLK wide pulse when the CTRL signal 902 is asserted, thus asserting the set signal 905 and configuring the flip-flop 1004 to output the enable signal. An equivalence circuit 902 outputs a one CLK wide pulse when the count in the counter 901 is equal to a predetermined value that is representative of the activation time 710. The output from the equivalence circuit 902 disables the counter 901, which will be re-enabled when the CTRL signal 902 is next asserted, indicating a new line time. The output from the equivalence circuit 902 also asserts the reset input 906, which deasserts the enable signal. In one embodiment, when the enable signal is deasserted, the output of the short pulse module 900 is equal to zero, the selected Row is returned to a bias voltage, e.g., 5 volts in the embodiment of FIGS. 7 and 8, the data enable circuit grounds the column electrodes, and the column level shifter 812 is disabled. In this way, the short pulse module 900 controls the time in which column level shifter 812 is active.

In one embodiment, the activation time 710 may be a minimum time required to change states of an interferometric modulator. However, this circuit may be used in conjunction with other types of displays in order to reduce the pulses provided to the displays. A short pulse module, such as the short pulse module 900, may be coupled to existing display drivers or may be incorporated in the display device.

FIG. 10 is a flow chart illustrating an exemplary method of controlling a level shifter. As described above, by reducing the time that either the row or column level shifter is activated, the total power drawn by a display driver may be reduced and the life of the power supply may be extended.

In a block 1010, data is written to a set of modulator elements in an array of modulator elements. In one embodiment, an array of modulator elements is refreshed by sequentially updating rows of elements. In this embodiment, the set of modulator elements comprises one or more rows of modulator elements. In an advantageous embodiment, the set of modulator elements comprises one row of modulator elements.

In another embodiment, the set of modulator elements may comprise a column of elements or any other subset of modulator elements in the array. For example, in one embodiment a portion of modulator elements of an array may require less frequent updates than another portion of the array. Accordingly, the set of modulator elements may include a portion of only those modulator elements that require more frequent updates.

In a block 1020, one of the level shifters that provide an amplified power signal to the display driver are disabled for a predetermined time. In the embodiment of FIGS. 7 and 8, for example, the column level shifter 812 is disabled during a column disable time 720. In another embodiment, the row level shifter may be disabled during a similar portion of each line time. In this embodiment, the column level shifter may be configured to provide a bias voltage to the modulator elements while the row level shifter is disabled. In an advantageous embodiment, the time during which one of the level shifters is disabled is greater than the time required for the modulator elements in the array to change states.

In a block 1030, the disabled level shifter is re-enabled. In the embodiment of FIGS. 7 and 8, for example, the column level shifter 812 is re-enabled near the beginning of each line time. Thus, the column level shifter 812 is able to provide the appropriate voltage levels to the data enable module 820 for setting the state of the modulator elements. In one embodiment, the column level shifter 812 is enabled prior to the start of a new line time so that the amplified voltage levels are available to the data enable module 820 when the line time begins. In another embodiment, the column level shifter 812 is enabled after the start of a line time and prior to an activation time, such as activation time 720. In an embodiment where the row level shifter is disabled during a portion of the line time, the row level shifter is re-enabled in block 1030.

With the level shifter re-enabled, the method returns to block 1010 and repeats blocks 1010, 1020, and 1030 for another set of modulator elements, such as another row of display elements.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

1. A method of updating a display region, the display region comprising a plurality of modulator elements arranged in a row and column configuration, wherein the modulator elements each have an actuated and a released state that may be selected by a voltage difference between a row electrode and a column electrode that are electronically coupled to respective modulator elements, each of the modulator elements being configured to maintain the state of the modulator element when a voltage within a stability window is applied between the row electrode and the column electrode of the respective modulator element, wherein each row of the modulator element is allotted a line time for changing states of the modulator elements of the respective row, the method comprising:
generating at least one row voltage with a row level shifter;
generating at least one column voltage with a column level shifter;
applying at least one row voltage to a selected row of modulator elements;
applying at least one column voltage to selected columns of modulator elements according to a desired state for the modulator elements; and
disabling the column level shifter prior to the completion of the line time, wherein the state of the modulator elements in the selected row are maintained by a voltage difference between the row voltage and a reference voltage, wherein the voltage difference is within the stability window.

2. The method of claim 1, wherein the reference voltage is provided by a data enable module.

3. The method of claim 1, further comprising enabling the column level shifter at about a start of a next line time.

4. A display comprising:
a row booster configured to generate a row voltage;
a column booster configured to generate a column voltage;
an array comprising a plurality of modulator elements, each of the modulator elements being connected to a column electrode and a row electrode and being configured to be driven by the row voltage and the column voltage, wherein a state of the modulator elements in a respective row of the array may be modified during a line time in which the row voltage is connected to the respective row electrode; and
a disable module configured to disable one of the boosters during a portion of the line time.

5. The display of claim 4, wherein the disable module is configured to disable the column booster during the portion of the line time.

6. The display of claim 5, wherein the row booster remains active during the disable portion of the line time and provides a bias voltage on each of the row electrodes.

7. The display of claim 6, wherein the bias voltage is about 5 volts.

8. The display of claim 5, further comprising a data enable module configured to output a reference voltage to the column electrodes of the array during the portion of the line time.

9. The display of claim 4, wherein the disable module is configured to disable the row booster during the portion of the line time.

10. The display of claim 9, wherein the column booster remains active during the portion of the line time and provides a bias voltage on each of the column electrodes.

11. The display of claim 10, wherein the bias voltage is about 5 volts.

12. A method of reducing power consumption of a display driver configured to drive each of a plurality of modulator elements in an array of modulator elements, wherein the display driver comprises a level shifter configured to generate an amplified voltage for driving the modulator elements, the method comprising:
(a) selecting a set of the modulator elements to be refreshed;
(b) refreshing the selected set of modulator elements, wherein the amplified voltage is applied to certain of the selected set of modulator elements in order to change a state of the certain modulator elements;
(c) after refreshing the selected set of modulator elements, disabling the level shifter for a predetermined time;
(d) after the predetermined time, enabling the level shifter; and
(d) repeating steps (a)-(d).

13. The method of claim 12, wherein the set of modulator elements comprises a row of modulator elements.

14. The method of claim 12, wherein the set of modulator elements comprises a column of modulator elements.

15. The method of claim 12, wherein the predetermined time is substantially equal to a line time of the display driver minus a time required for changing states of any of the modulator elements.

16. The method of claim 12, wherein a time allotted for the step of refreshing is greater than a time required for any of the modulator elements to change states.

17. The method of claim 16, wherein the time allotted for the step of refreshing is about 10 milliseconds.

18. A display driver configured to drive each of a plurality of modulator elements in an array of modulator elements, the display driver comprising
a voltage level shifter; and
means for disabling the voltage level shifter for a predetermined time after refreshing a selected set of modulator elements.

19. The display driver of claim 18, further comprising:
means for enabling the level shifter after the predetermined time.

20. A display comprising:
a row booster configured to generate a row voltage;
a column booster configured to generate a column voltage;
an array comprising a plurality of bi-stable display elements, each of the display elements being connected to a column electrode and a row electrode and being configured to be driven by the row voltage and the column voltage, wherein a state of the display elements in a respective row of the array may be modified during a line time in which the row voltage is connected to the respective row electrode; and
a disable module configured to disable one of the boosters during a portion of the line time.
